(19) United States
(12) Patent Application Publication
(10) Pub. No.: US 2025/0280845 A1
(43) Pub. Date: Sep. 11, 2025

(54) FOOD PRODUCTION METHOD

(71) Applicant: Patrick Vincent Phillips, Smoky Lake (CA)

(72) Inventor: Patrick Vincent Phillips, Smoky Lake (CA)

(21) Appl. No.: 18/596,837

(22) Filed: Mar. 6, 2024

(51) Int. Cl. A23C 19/097

(52) U.S. Cl. CPC A23B 11/604; A23C 2250/35; A23C 2270/15

(57) ABSTRACT

A food production method that is operable to produce a smoked and freeze dried cheese product wherein the cheese product of the present invention is provided in a plurality of flavors. The method of the present invention initiates with smoking of a cheese block wherein the smoking occurs for at least an hour and is executed at a temperature range of thirty two to seventy five degrees. The smoked cheese block is subsequently cut into a multitude of small portions wherein the portions are placed in a freezer at a temperature of minus ten degrees Fahrenheit. While the cheese portions are in the freezer, a vacuum is placed on the interior of the freezer for at least twenty four hours. The cheese portions are tested for an active water content and ensuing achieving a desired measurement for active water content the cheese portions are packaged.

### FIELD OF THE INVENTION

The present invention relates generally to food production methods, more specifically but not by way of limitation, a method configured to produce a smoked and freeze dried cheese product that can be stored for several years and is provided in a plurality of flavors.

### BACKGROUND

Snacking is becoming increasingly popular, with more than seventy percent of people reporting they snack at least twice a day. There have been recent medical studies to examine whether snacking affects health and if the quality of snack foods matters. Studies have shown that the quality of snacking is more important than the quantity or frequency of snacking. Choosing high quality snacks over highly processed snacks is likely beneficial to the overall health of the individual. Timing of snacking is also important, with late night snacking being unfavorable for health.

Data analysis has shown that snacking on higher quality foods, that is, foods that contain significant amounts of nutrients relative to the calories they provide have been associated with better blood fat and insulin responses. It has also been observed in snacking studies that late-evening snacking, which lengthens eating windows and shortens the overnight fasting period, was associated with unfavorable blood glucose and lipid levels. Healthy snacking performed at the right times has proven to be favorable. Retail grocery stores are abundant with poor quality snack foods that are high in sugar, fat and are also high in chemical additives.

Accordingly, there is a need for a food production method that is operable to produce a healthy snack food wherein the present invention provides several flavor options and a food product that can be stored for a substantial amount of time.

### SUMMARY OF THE INVENTION

It is the object of the present invention to provide a food production method configured to provide a smoked and freeze-dried cheese product wherein the present invention includes a step of exposing a cheese block to food grade hickory smoke.

Another object of the present invention is to provide a method that is operable to produce a snack food that can be stored for a substantial amount of time wherein the present invention includes a step of smoking the cheese product within a temperature range of thirty two to seventy five degrees Fahrenheit.

A further object of the present invention is to provide a food production method configured to provide a smoked and freeze-dried cheese product wherein the present invention includes a step of cutting the cheese block into small portions.

Yet a further object of the present invention is to provide a method that is operable to produce a snack food that can be stored for a substantial amount of time wherein the present invention includes a step of exposing the small portions of cheese to a temperature of minus ten degrees Fahrenheit.

Still another object of the present invention is to provide a food production method configured to provide a smoked and freeze-dried cheese product wherein the present invention includes a step placing a vacuum on the frozen cheese portions.

An additional object of the present invention is to provide a method that is operable to produce a snack food that can be stored for a substantial amount of time wherein the present invention includes a step of testing the cheese portions for an active water content.

Yet a further object of the present invention is to provide a food production method configured to provide a smoked and freeze-dried cheese product wherein the present invention includes a step of placing the cheese portions into a container with an oxygen absorber.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a flowchart of the process of the present invention.

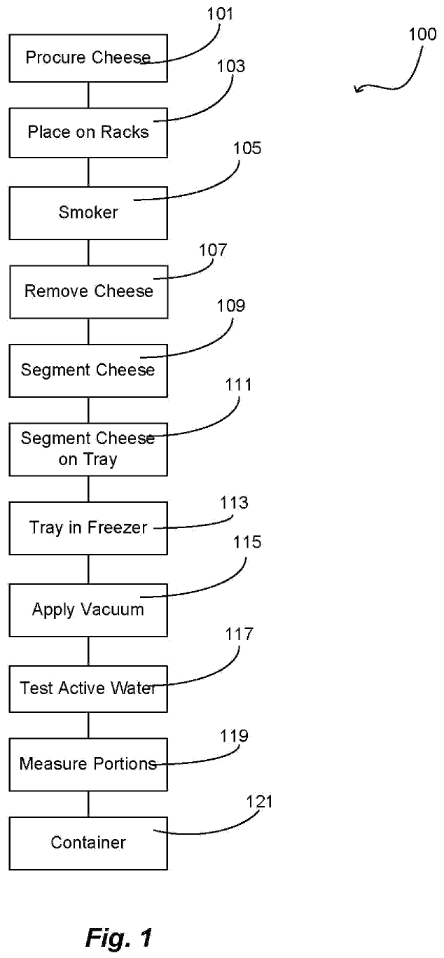

### DETAILED DESCRIPTION

Referring now to the drawings submitted herewith, wherein various elements depicted therein are not necessarily drawn to scale and wherein through the views and figures like elements are referenced with identical reference numerals, there is illustrated a food production method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the food production method 100 is operable to produce a freeze dried and smoked cheese product wherein the product is provided in a plurality of flavors. It should be understood within the scope of the present invention that various alternate types of cheese could be utilized. In step 101, a cheese block is procured from a desired source. Step 103, the cheese block has any wrapper therearound removed and is placed on a rack. Step 105, the rack having the cheese superposed thereon is placed in a smoker. The smoker is loaded with food grade hickory wood pellets wherein the pellets are ignited in order to initiate the smoking process. The smoker is maintained at a temperature range of thirty two degrees and seventy five degrees Fahrenheit during the smoking process. The smoking process is performed for one hour. While an hour for the smoking process is preferred, it should be understood within the scope of the present invention that the smoking process time could be more or less than an hour.

In step 107, the cheese block is removed from the smoker. Step 109, the cheese block is cut into a multitude of portions utilizing a tool such as but not limited to a guitar pastry cutter. In a preferred embodiment of the present invention the cheese is cut into small portions that are approximately one-quarter of an inch in width and one half an inch in height. It should be understood within the scope of the present invention that the cheese cut be cut into alternate size portions. In step 111, the cut portions of the cheese are placed in a single layer onto a stainless steel tray. Step 113, the stainless steel tray is placed in a freezer wherein the freezer is subsequently set to minus ten degrees Fahrenheit. In step 115, once the cheese portions are frozen, a vacuum is applied to the interior of the freezer. In a preferred embodiment of the present invention the vacuum applied to the interior of the freezer containing the cheese portions is five hundred millitorr. The vacuum is maintained for a period of at least twenty four hours and it should be understood that the temperature is held at minus ten degrees during application of the vacuum.

Step 117, the cheese portions are tested for water content utilizing an appropriate tool such as an active water tester. The active water must read 0.20 or lower to indicate the process step has been successfully executed. The vacuum and temperature exposure continues until the cheese portions have an active water content less than 0.20. In step 119, ensuing the cheese portions achieving an active water content less than 0.20, the cheese portions are measured into a desired quantity for packaging. By way of example but not limitation, the cheese portions can be measured into fifty two gram portions. Step 121, ensuing measuring of the cheese portions, the cheese portions are placed into a suitable container along with an oxygen absorber for storage and subsequent consumption. In a preferred embodiment of the present invention the cheese portions are placed into a mylar bag for storage. The mylar bag is sealed employing a heat sealer and a plurality of mylar bags can be placed in boxes for shipping thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A food production method operable to produce a smoked and freeze dried cheese product wherein the food production method comprises the steps of:
procuring at least one block of cheese;
placing the at least one block of cheese in a smoker;
smoking the at least one block of cheese for at least one hour, wherein the at least one block of cheese is smoked at a temperature range between thirty two and seventy five degrees Fahrenheit;
removing the at least one block of cheese from the smoker;
cutting the at least one block of cheese into a multitude of cheese portions;
placing the cheese portions onto a stainless steel support tray, wherein the cheese portions are superposed the support tray in a single layer;
inserting the support tray into a freezer;
setting a temperature of the freezer, wherein the freezer is set to a temperature of minus ten degrees Fahrenheit;
maintaining the cheese portions in the freezer for at least an hour;
pulling a vacuum within the freezer, wherein the freezer is maintained at a vacuum for at least twenty four hours;
testing at least one of the cheese portions for an active water content;
allocating a portion of the cheese portions, wherein the allocated cheese portions are of an amount for packaging; and
packaging the cheese portions, wherein the allocated portion of cheese portions are packaged ensuing attainment of a required active water content amount.

2. The food production method operable to produce a smoked and freeze dried cheese product as recited in claim 1, wherein the active water content must be less than 0.20 prior to packaging the cheese portions.

3. The food production method operable to produce a smoked and freeze dried cheese product as recited in claim 2, wherein the vacuum is 500 millitorr.

4. The food production method operable to produce a smoked and freeze dried cheese product as recited in claim 3, wherein the allocated cheese portion is packaged in a mylar bag having an oxygen absorber placed therein.

5. The food production method operable to produce a smoked and freeze dried cheese product as recited in claim 4, wherein the at least one cheese block is smoked with food grade hickory pellets.

6. The food production method operable to produce a smoked and freeze dried cheese product as recited in claim 5, wherein the cheese portions have a size of one-quarter of an inch in width and one half an inch in height.
